(19) United States
(12) Patent Application Publication
(10) Pub. No.: US 2008/0215588 A1
(43) Pub. Date: Sep. 4, 2008

(54) Electronic object sharing system

(75) Inventor: Peter Mattheisen, Grevenbroich (DE)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Toshiba Europe GmbH

(21) Appl. No.: 11/713,343

(22) Filed: Mar. 2, 2007

(51) Int. Cl. G06F 7/04

(52) U.S. Cl. 707/9

(57) ABSTRACT

According to one embodiment, a system and method is described for assigning access rights to documents and controlling these access rights within a database environment thereby preventing unauthorized persons from viewing certain documents. According to one embodiment of the invention, a method of operation comprises determining if a user has access rights to an electronic object stored in a database. If not, information associated with the electronic object is precluded from being displayed.

### FIELD

Embodiment of the invention relate to the field of database management. More specifically, one embodiment of the invention generally relates to a system and method for assigning access rights to documents and controlling these access rights within a database environment thereby preventing unauthorized persons from viewing certain documents.

### BACKGROUND

Currently, one of the most common methods for managing access to documents involves the use of a file server. The file server features directories (folders) that are created and serve as a container for documents. A user can retrieve documents from and store documents within folders. Depending on the access rights, an administrator or even a user has the ability to create subfolders in order to group documents.

Typically, within a larger company for example, document storage within file servers lacks an overall logic and order since folder structures are created by hundreds of employees with different ideas about content classification. As a result, the majority of information stored in folders becomes “buried,” and in the future, is available only for those who know the destined location. This defeats one of the prime purposes: file sharing.

Also, the documents in these folders are not equipped with categories based on company standards which would make a systematic search possible. As a result, a full text search is conducted in order to locate a particular document, which is an inferior searching tool. As an example, by searching for a piece of text in the document content, full text searches normally provide imprecise results by listing tens or hundreds of “matches” which have again to be scanned manually. This is a time consuming and inefficient process for the user.

Also, full text searches place an enormous load on the file server when many users apply this function as their only search method. Moreover, such scanning is extremely difficult where file servers are distributed over multiple locations and such search tasks have to be transported via wide area networks (WAN) links with a limited bandwidth.

It is contemplated, however, that MICROSOFT® Rights Management Systems (RM Systems for Windows Server 2003) allow users to describe access rights on a document level. These documents can be stored on file servers or on share point server document lists. However, in this case, RM Systems suffer from several disadvantages.

For instance, in the document list (in a folder of a file server or in a document list of a share point site), all users are presented with the same list of documents. Therefore, users are allowed to see those documents to which she has no access rights. Only at the moment when the user tries to open the document would a message inform her that she is not entitled by the author to read it.

So, there are no dynamic filters based on a user's access rights. In a larger environment with thousands of documents, this lack of filtering may be upsetting to a searcher by complicating the search results and could become a security concern because, in some cases, the title of a document may convey sensitive information.

Furthermore the definition of access rules with RMS is limited to the use of user names or already existing user groups which might not be in line with the publisher's understanding. The unsynchronized maintenance of such user groups could lead to unwanted information leakage.

### BRIEF DESCRIPTION OF THE DRAWINGS

Embodiments of the invention may best be understood by referring to the following description and accompanying drawings that are used to illustrate various features of the embodiments of the invention.

FIG. 1 is an exemplary embodiment of an object management system.

FIG. 2 is an exemplary embodiment of the software architecture of the object sharing system of FIG. 1.

FIG. 3 is an exemplary embodiment of the operations of the object management system for publishing of an electronic object.

FIG. 4A is an exemplary embodiment of a main window illustrating those electronic objects to which the user has access rights.

FIG. 4B is an exemplary embodiment of a grid layout dialogue window produced for configuring the main window of FIG. 4A.

FIG. 4C is an exemplary embodiment of columns of main window including natural metadata.

FIG. 4D is an exemplary embodiment of start functions to sort and arrange the grid content or to launch other dialogues for publishing, searching or check-in of electronic objects.

FIG. 4E is an exemplary embodiment of selection of a pull-down menu option to launch user defined search profiles.

FIG. 5A is an exemplary embodiment of an Edit Search dialogue window.

FIG. 5B is an exemplary embodiment of a dialogue window generated to provide the user with categories of searchable information, including metadata.

FIG. 5C is an exemplary embodiment of an Edit Search Dialogue that illustrates a unique identifier of a search profile for importing to another user.

FIG. 6A is an exemplary embodiment of a publishing dialogue window.

FIG. 6B is an exemplary embodiment of a dialog section for editing or creating an access set.

FIG. 6C is an exemplary embodiment of a section of the publishing dialogue window featuring the stored access rules for selection.

FIG. 7A is an exemplary embodiment of a context menu opened from selection a selectable element in main window of FIG. 4A.

FIG. 7B is an exemplary embodiment of a check-in dialogue window generated upon selection of check-in dialogue button located in main window of FIG. 4A:

### DETAILED DESCRIPTION

Embodiments of the invention generally relate to an electronic object management system and method for assigning metadata to an electronic object and the metadata being used for access rights control and for describing the content and author of the electronic object in order to improve searching accuracy.

In general, the management system for electronic objects comprises a database that holds the objects' content along with metadata associated with the electronic object. The management system further comprises a Graphical User Interface (GUI) which provides a list of links to the electronic objects, where the content of this list is dynamically built based on the access rights the authenticated user has for these objects. As a result, a uniform method to present information is provided for all participating users where the user sees her individual list based on her access rights. A user would not see an object link in the list to which she has no access rights.

In order to determine if a user has access rights to an electronic object in the database, a dynamic comparison is conducted between the user's Active Directory attributes and metadata relevant to the access rights that is stored for electronic objects in the database in order to describe its target audience.

Access rights to electronic objects in the database are therefore not expressed via user account names or groups, populated with user account names, but only by attributes of targeted users including, but not limited or restricted to the target users' organizational position, business area, job responsibilities held by the user, etc. This isolation of names from access conditions offers many advantages for the information management.

For instance, in the case where a user gets promoted or assigned to a new responsibility or business area, it will be sufficient to express this change in her Active Directory attributes. Once the promotion is in effect, she will have access to all objects in the database that map with her newly assigned position.

When a user publishes a new object (e.g. a document) into the database, a graphical user interface allows her to define the access rule with which this electronic object will be stored. This access rule is linked with the object and determines who else, beside the publisher, will have the right to read, modify and/or delete the published object. The publisher creates this access rule by selecting one or multiple values from one or more category lists which are mapping with the fields in the Active Directory that can be used to describe a user's organizational position, business area, responsibility, etc. In this way, the access relevant metadata are created.

Metadata is not only used for access rights control as described above but is also used to describe the content and the author of an object as well as used by the user to define search conditions. There are two classes of metadata connected with every object: (1) user-selected metadata (hereinafter referred to as “attached metadata”) and (2) user-independent metadata (hereinafter referred to as “natural metadata”). The attached metadata includes category values which are selected during the publishing phase from pre-defined lists in order to describe the electronic object such as information concerning the content, purpose, language, business process relation, etc. Natural metadata includes category values which can be linked to a published object in an automatic way without any effort by the publisher.

More specifically, the Active Directory (AD) attributes of the publisher may be pulled from the publisher's AD user record and stored as natural metadata of the published object. Also, data may be retrieved from the object attributes include, but are not limited or restricted to one or more of the following: technical file name, the file extension and the file size. Besides object attribute data, the natural metadata may include data associated the user's system interaction such as the publishing date, publisher name or the like.

Certain details are set forth below in order to provide a thorough understanding of various embodiments of the invention, albeit the invention may be practiced through many embodiments other than those illustrated. Well-known components and operations are not set forth in detail in order to avoid unnecessarily obscuring this description.

In the following description, certain terminology is used to describe features of the various embodiments of the invention. For example, the terms “electronic object” or “object” describe an item associated with access-controlled content. Types of items include, but are not limited or restricted to a document, an application, a link, an image or series of images, a video or audio clip, or the like.

The term “component” refers to hardware and/software. Herein, “software” generally denotes executable code such as an operating system, an application, an applet, a browser, a routine or even one or more instructions (generally referred to as a “module”). The software (module(s)) may be stored in any type of memory, namely a suitable storage medium such as a programmable electronic circuit, a semiconductor memory device, a volatile memory (e.g., random access memory, etc.), a non-volatile memory (e.g., read-only memory, flash memory, etc.), an optical disk (e.g., compact disk, digital versatile disc “DVD”, etc.), a drive (e.g., hard drive, flash.drive, tape drive, etc.) or the like.

I. General Architecture

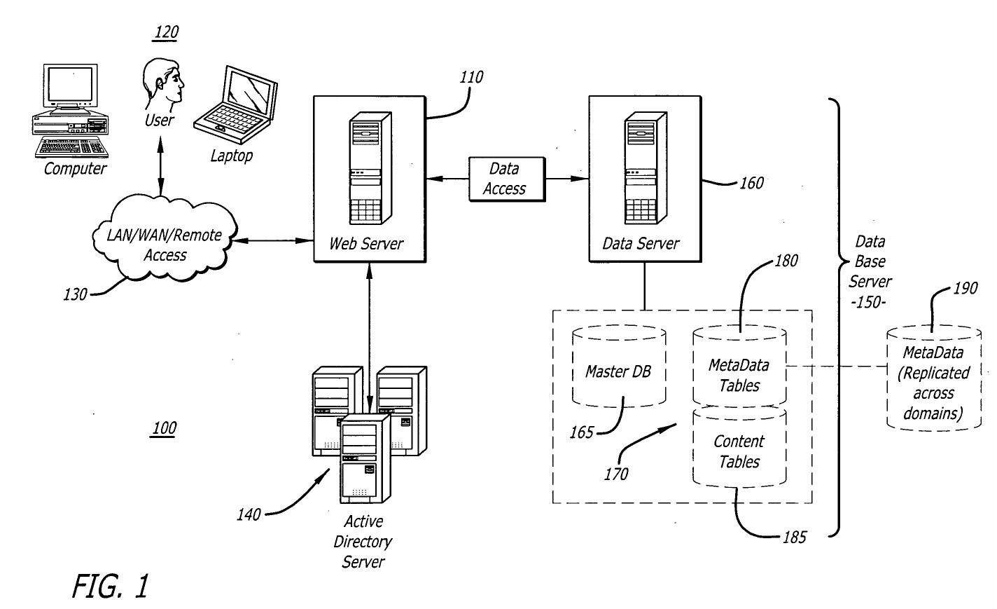

With respect to FIG. 1, an exemplary embodiment of an object management system 100 is shown. System 100 comprises a web server 110 that operates as the entry point to the application. Web server 110 receives requests from an end user 120 over a public or private network 130. These requests may involve download requests for electronic objects that the end user has access to or search requests for a listing of user-accessible documents with particular metadata.

The determination as to whether or not the end user has access to a particular electronic object is accomplished by an authentication process performed by a data access logic of application 220, running on Web server 110 by comparing dynamically the end users Active Directory attributes, retrieved from Active Directory server 140 based on the end user's successful network authentication, with the access definitions of all published objects. For instance, according to one example, Web server 110 compares attributes for end user 120 that are stored within Active Directory server 140 with access rights to the electronic object. Such determination is made before downloading the object or displaying information (e.g., title, link parameters, etc.) concerning the object.

Database server 150 is responsible for managing the storage and integrity of data in system 100. According to one embodiment of the invention, database server 150 comprises a data server 160 (e.g., MICROSOFT® SQL Server), a master database 165 and storage component 170. Herein, master database 165 is a separate database that holds the master tables for metadata categories and values associated with these categories. Storage component 170 includes metadata tables 180 and content tables 185 to store metadata and content for each stored electronic object.

Web server 110 interfaces with data server 160 to access and update data. Database server 150 may be provided for every domain. It is contemplated that a database server may be provided for every domain (e.g., multiple database servers to support different locations within a multinational corporation, different divisions within a corporation located in the same area, etc.). However, only metadata tables 180 are replicated across the servers in every domain as represented by replicated metadata tables 190. Content tables 185 will remain in the database domain from where it is published and are not replicated.

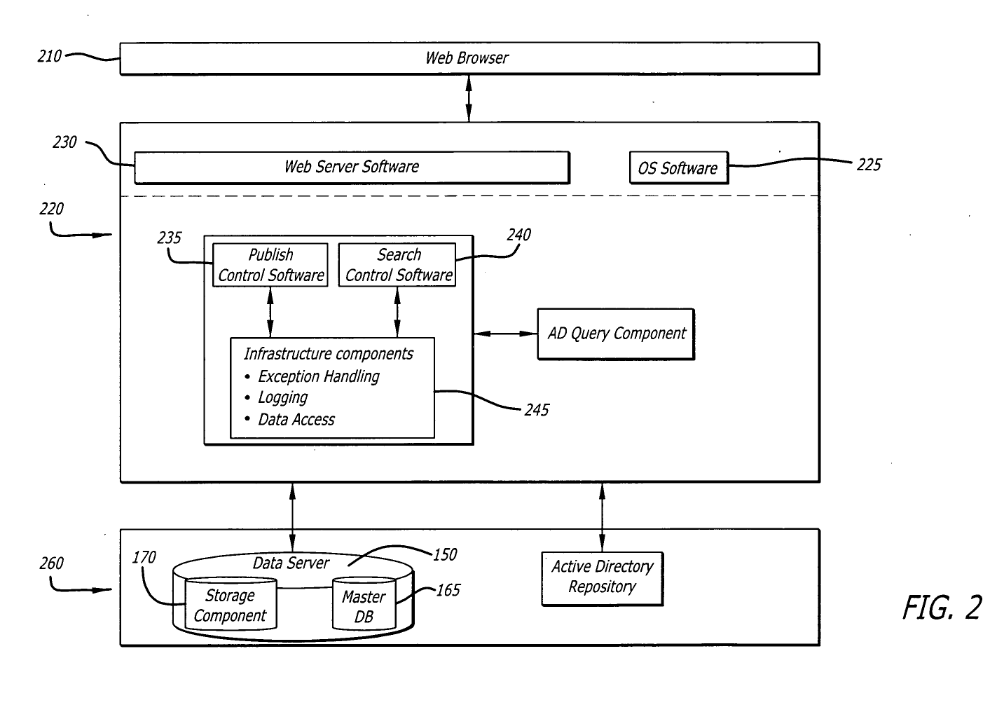

Referring now to FIG. 2, an exemplary embodiment of the software architecture of object sharing system 100 of FIG. 1 is shown. For clarity, discussion of various Open Systems Interconnection (OSI) layers of software 200 for object sharing system 100 is described. Herein, a Presentation Layer 210 of software 200 is accessible from a browser based front end. Presentation layer 210 allows users to remotely access applications associated with the software over network 130 of FIG. 1.

Application layer 220 includes operating system (OS) software 225 along with software 230 to establish communications with web server 110 of FIG. 1. In addition, object management system 100 includes software to define the access rule upon which an electronic object will be granted access (hereinafter referred to as “publish control software” 235) and software to assign and search for metadata associated with the electronic object (hereinafter referred to as “search control software” 240). Moreover, system 100 further includes components supporting the object management software, such as software directed to infrastructure components 245 involved in error handling and data access for example, and software 250 responsible for querying the active directory using Lightweight Directory Access Protocol (LDAP).

Data link layer 260 interacts with Application layer 220 with the DSS database including a set of tables related to metadata, and other tables related to content data. Metadata tables can be replicated across all domains. Content tables will not be replicated. Moreover, data link 260 operates with an Active Directory repository 270 that stores Active Directory information for users and such information may be fetched for each user in the event of shared resources.

II. General Operations of the Object Management System

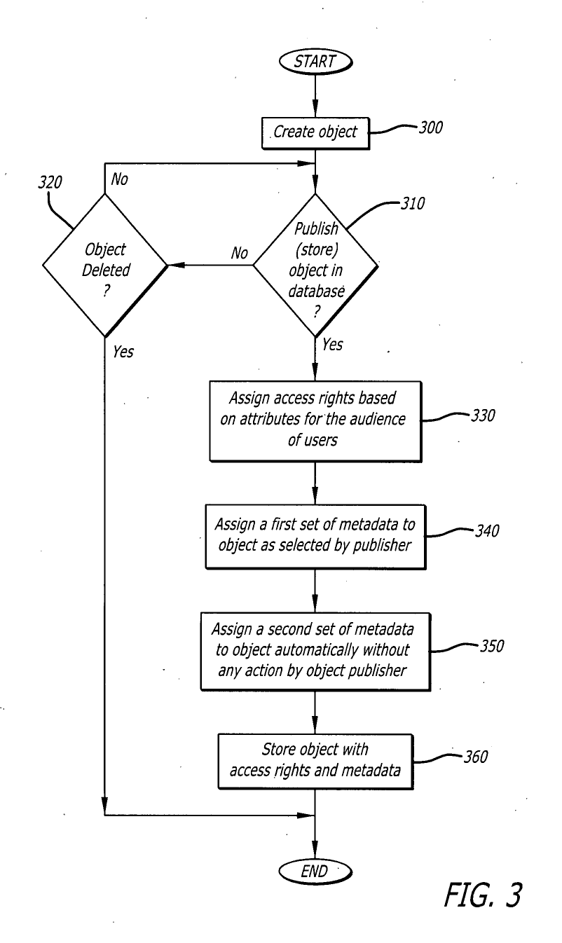

Referring to FIG. 3, an exemplary embodiment of the operations of the object management system for publishing of an electronic object is shown. Initially, an electronic object is created (block 300). Thereafter, a determination is made whether the electronic object is to be published, namely stored and accessible by at least the publisher and most likely other persons (block 310). If the electronic object is not to be published, the operations are discontinued (block 320). However, if the electronic object is to be published, access rights are assigned based on attributes of the targeted audience of users for the electronic device (block 330).

Herein, as described, an access rule is linked to every electronic object (e.g. document). Each access rule describes clearly, based on Active Directory attributes, the audience of users who have Read and/or Write access to the electronic object. It is not necessary for a user to store the electronic object in a specific location in order to control the access to the information. The location is independent from the access rights which are directly linked to the object.

The access rule is described by the publisher of the object directly. There is no risk that an activity by an administrator or colleague can violate the access rule idea of the publisher. The rule is visible to all users who have at least read access to the object.

The user builds the access rules by any combination of the AD attributes, describing the users. If a user changes her department, responsibility, location, hierarchy, name etc., no adjustment is necessary in any access rule definition. As soon as the change is reflected in the AD attributes, the relevant objects will become accessible to this person. Access rules based on AD attributes of the users are compatible with computer based processes of organizations (electronic workflows, task allocation, corporation-wide collaboration).

Besides assigning access rights to the electronic object, a first set of metadata is assigned to the object (block 340). Herein, according to one embodiment of the invention, the first set of metadata constitutes the “attached metadata,” which is selected by the publisher and is used to describe the content of the electronic object. The description of the content includes assigning category values which are selected, normally from pre-defined lists in order to describe the electronic object. The description may include, but is not limited or restricted to a purpose of the object, language utilized within the object, business process relation, etc.

Thereafter, a second set of metadata is assigned to the object (block 350). According to one embodiment of the invention, the second set of metadata constitutes the “natural metadata,” which is assigned automatically without any action by the publisher. As an example, certain category values are linked to a published object in an automatic way without any effort by the publisher. These category values typically are the AD attributes of the publisher (e.g., publisher name, company, hierarchy etc.) and attributes associated with the publishing of the electronic object such as publication date, name of the electronic object, size (in bytes, kilobytes, megabytes, etc.) of the electronic object or the like.

Thereafter, the electronic object is stored with the assigned access rights and metadata (block 360).

III. General System Overview with GUI Illustrations

A. Main Window

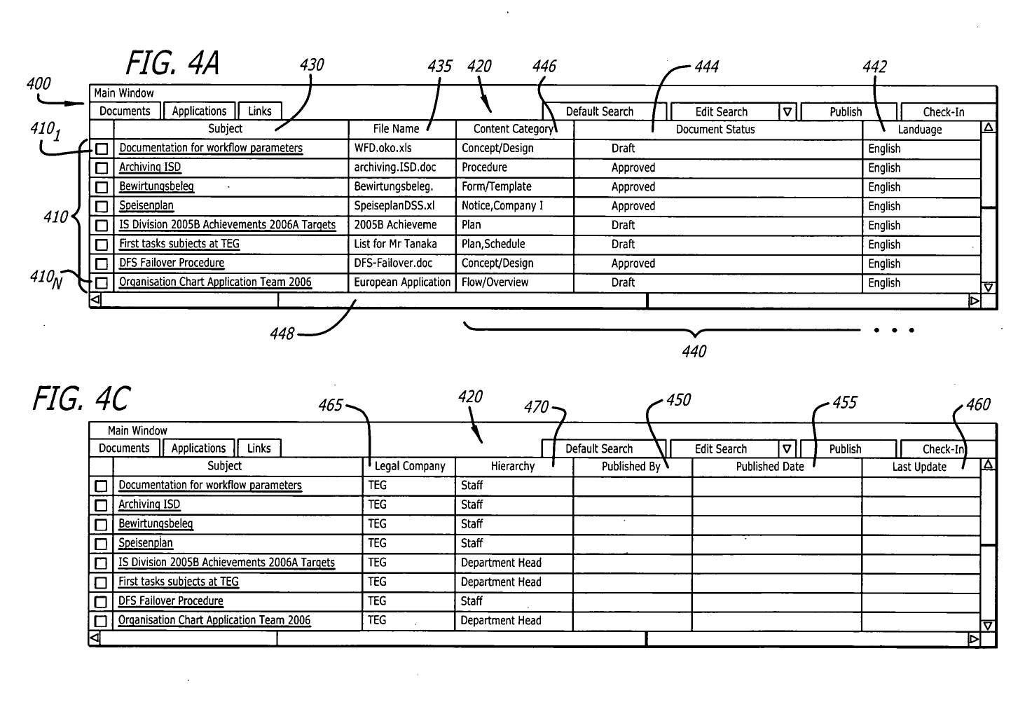

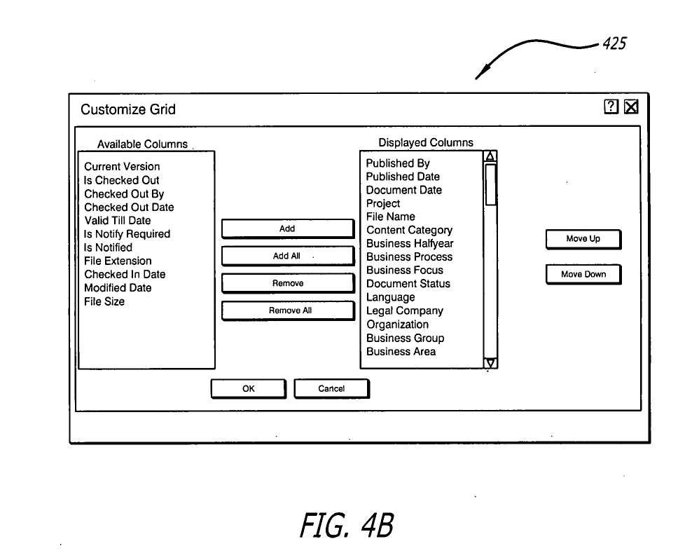

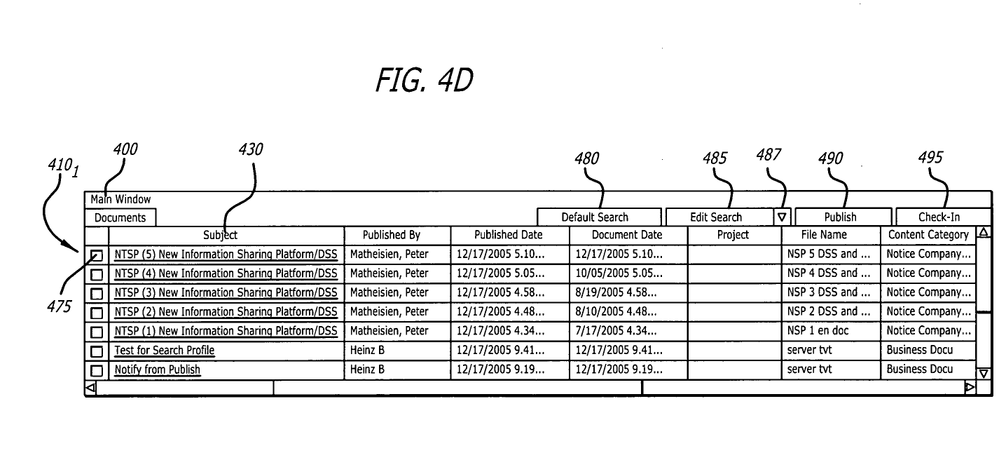

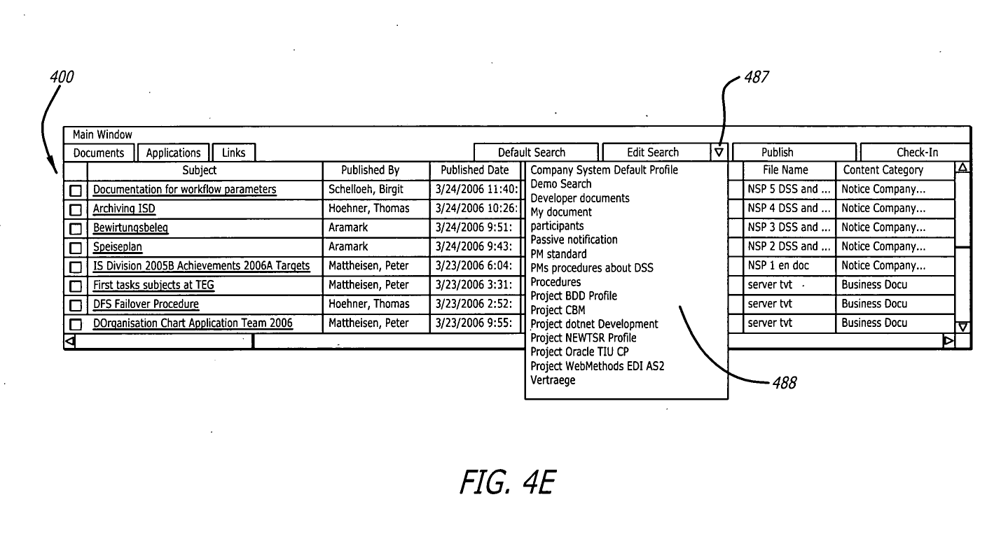

Referring now to FIG. 4A, an exemplary embodiment of a main window 400 illustrating those electronic objects to which the user has access rights is shown. Herein, according to one embodiment of the invention, main window 400 is configured in a grid layout listing electronic objects 410, namely listing up to “N” electronic objects 410₁-410_{N} (N≧1) for this embodiment, to which the authenticated user has access rights (and which fall in her selection criteria defined in a search profile previously conducted). Columns 420 (e.g., columns 420₁-420_{M}, where M≧1) of main window 400 represent metadata categories and their headers are used to identify the metadata category name. The entries within main window 400 are populated with individual metadata category values of listed electronic objects 410₁-410_{N}. It is contemplated that each entry may require information to be input, or may be configured with a pull-down menu option to produce a standardized category list in order to provide restriction on the inputted data.

A user can save any number of search profiles for her personal use in order to avoid a redefinition of repeating queries. A search profile stores the following information for a user: (1) the selection criteria; (2) the selection of columns to be displayed in main window 400; (3) the horizontal sequence in which columns 420₁-420_{M} are arranged in main window 400; (4) the sorting instruction; and (5) the search method (Standard Search or Sharp search). Once defined, the search profiles can be opened via the Edit Search Dialogue (for modification if required) or they can be applied directly from main window 400 with a quick launch function that offers all profiles a user has defined as described below.

For instance, main window 400 offers various functions that allow the user to adjust the content and arrangement of the columns to her preference. With a double-click on a header of a column (e.g., column 420₁), the width of column 420₁ will adjust automatically to the size that is necessary in order to display the full text length of the cell with the longest text string. Similarly, with a right mouse click on any column header, a grid layout dialogue window 425 is produced as now shown in FIG. 4B. This dialogue window 425 allows a user to select what information to illustrate within main window 400. For instance, the user can decide which columns of metadata should be displayed in the grid layout of main window 400 and which should be hidden. Also, the user can also define the horizontal sequence of columns 420₁-420_{M}.

Referring back to FIG. 4A, according to one embodiment of the invention, each electronic object (e.g., object 410₁) is identified by a subject entry 430, a file name entry 435, and the metadata 440 as either decided by the publisher or retrieved from the publisher's AD attributes automatically. For instance, for management systems of a multi-national company, metadata 440 may include attached metadata such as a language entry 442 to denote the language of the stored electronic object. Metadata may further include a status entry 444 to denote if it is a stored “draft” or “approved” final version and a content entry 446 to provide a general category for the content associated with the stored electronic object.

Herein, the user can scroll main window 400 horizontally using a scroll bar 448 to uncover and review all category columns that are available. As shown in FIG. 4C, some of these columns 420 may include natural metadata. According to one embodiment of the invention, one of columns 420 may include a Published entry 450 that identifies the publisher of electronic object 4101. Moreover, selected columns 420 may include a Published date entry 455 that identifies the publication date (stored date), a Completion date entry 460 that identifies the date that electronic object 410₁ was last updated, a Company entry 465 that identifies the company employing the publisher, and a Hierarchy entry 470 that identifies the title of the publisher of electronic object 410₁.

From main window 400, as shown in FIG. 4D, the user can start functions to sort and arrange the grid content or to launch other dialogues for publishing, searching or check-in. For instance, by selecting (clicking) subject entry 430 of electronic object 410₁, the object is opened. Selectable element 475 may be selected and used to select a document to be part of an advanced search operation. For the advanced search operation, the user can enter a search word that is then used for a full text search in the content of the selected documents. As a result, the advanced search operation will provide a list of those electronic objects, selected for this search, in which the search word has been found.

As shown in this embodiment, there are four (4) dialogue buttons 480, 485, 490 and 495. These dialogue buttons 480, 485, 490 and 495 are used to provide accessibility between the results displayed and other functionality available within the object management system.

A first dialogue button 480 may be selected to return to the default profile and avoid any changes made in the selection or column arrangement for main window 400. The default profile is defined as a layout that illustrates all objects to which a user has access rights. The particular layout in which the objects are illustrated may vary, and is frequently set by the system administrator who defines the default profile. In the event that a user wants to define one of her search profiles as her default profile, this is possible using second (Edit Search) dialogue button 485 as described below.

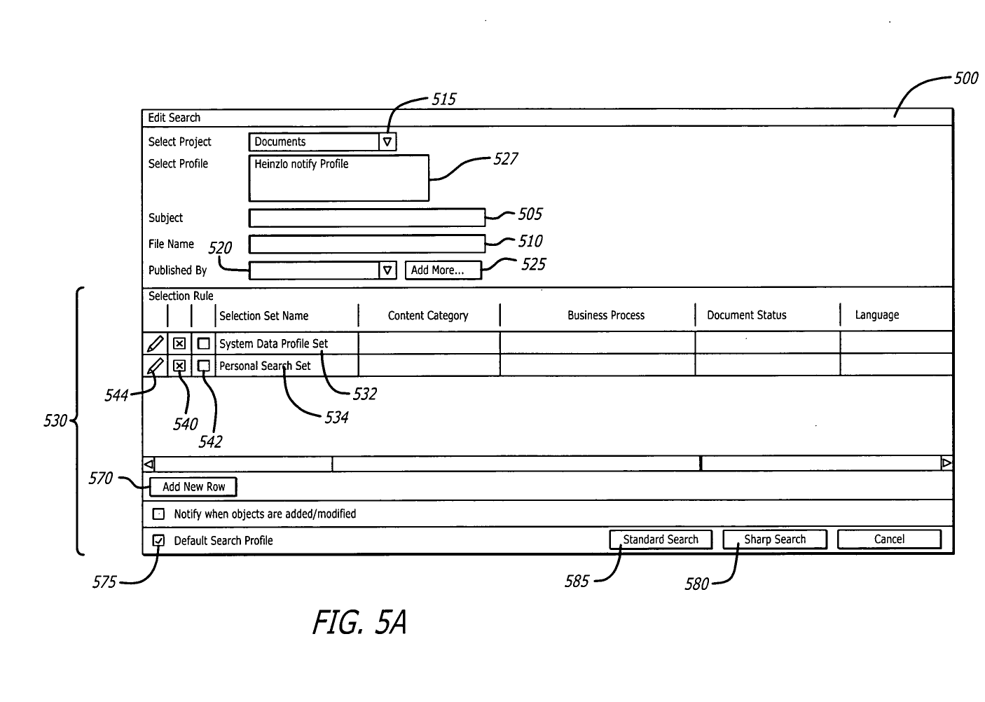

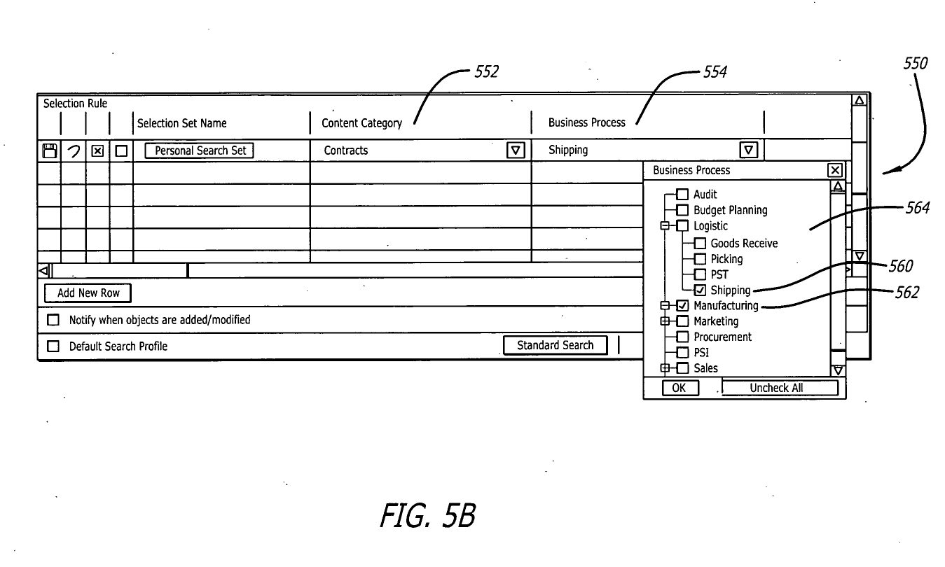

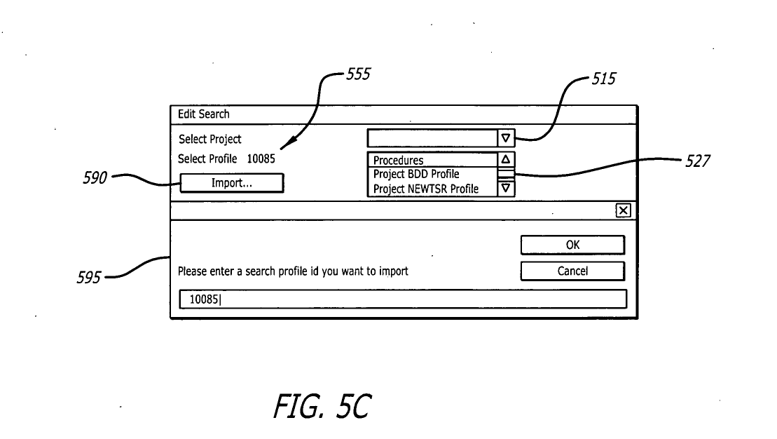

A second dialogue button 485 may be used to edit the search criteria. Upon selecting the second dialogue button 485, an Edit Search dialogue window is opened where the user can pick the required search profile from a profile list box as described in FIG. 5A. Once selected, the content of the Edit Search dialogue window will adjust to the selection criteria stored under the selected profile. From here, the user can either execute the search (and return to the result on main window 400) or modify the conditions to start an ad-hoc search or overwrite the loaded profile with the amended conditions.

In case a user wants to execute a once defined search profile quickly, it is not necessary to select second dialogue button 485 to open the Edit Search dialogue. Adjacent to second dialogue button 485 in main window 485 is a pull-down menu option 487. Once pull-down menu option 487 is selected as shown in FIG. 4E, a list 488 will be shown with all personal search profiles that the user has created and saved. Any of these search profiles can be launched by selecting that profile.

The third and fourth dialogue buttons 490 and 495 may be selected to illustrate publish and check-in dialogue boxes in order to store an electronic object and to return an electronic object to the object management system as further described below in detail.

B. Edit Search Dialogue Window

Referring to FIG. 5A, an exemplary embodiment of an Edit Search dialogue window 500 is shown. This dialogue window 500 offers the option to define search criteria in any combination of the metadata. According to one embodiment of the invention, Edit Search dialogue window 500 comprises search entries for subject 505, file name 510 and various types of metadata. According to this embodiment of the invention, the searchable metadata may include, but is not limited or restricted to a project name 515 extracted from a standardized category list, a name of a publisher 520. Of course, the MORE button 525 may be selected to enable the user to select other “attached” or “natural” metadata for searching purposes. Edit Search dialogue 500 includes a select profile entry 527 that allows the user to select a pre-defined search profile.

Referring still to FIG. 5A, Edit Search dialogue 500 further comprises a section 530 that allows for adjustment, deletion or addition of a selection rule. The “selection rule” defines the criteria upon which the search is conducted. At a minimum, there is at least one saved selection rule, namely the System Default Profile set 532, which cannot be deleted by the user. Herein, System Default Profile 532 and Personal Search 534 are illustrated.

As shown, according to one embodiment of the invention, each selection rule may be adjusted, deleted or selected to use during a search through selection one of a number of elements 540, 542 and 544. A first element, when selected, causes Personal Search 534 to be deleted. Of course, before deletion, a dialogue may request confirmation by the user.

A second element 542, when selected, causes the parameters listed in the search to be used. It is contemplated that multiple search sets can be collectively used to refine the search parameters.

A third element 544, when selected, allows the user to edit the selection set. For instance, as shown in FIG. 5B, a dialogue window 550 is generated that provides the user with categories of searchable information, including metadata, and allows the user to select and alter the particulars for Personal Search 534. Herein, as shown, Personal Search 534 currently is structured to search for all Contracts (Content Category 552) related to Shipping (Business Process Category 554).

At any point in the metadata selection process for editing a search, the user can select multiple values to broaden the search. Multiple selections within one category are considered by the system's search function as a logical OR condition, unlike selections within different categories being considered as logical AND conditions. As shown, based on the newly edited Personal search 534, all contracts shall be selected which involve Shipping or Manufacturing by selecting entries 560 and 562 within a standardized category list 564 for Business Process Category 554.

As further shown in FIG. 5A, section 530 further comprises an “Add New Row” dialogue button 570 that, when selected, allows another search set to be created. Also, different search sets can be selected as the default search profile (as described above) by selection of element 575.

As illustrated in FIG. 5A, the user can select among various methods for searching and can combine search sets. If desired, the user can store the search condition in a search profile for later reuse. The searches can be performed in accordance with selected attached or natural metadata as shown in FIG. 5B.

The user can select between two search modes. The management system is designed to find electronic objects based on metadata and other information even though the searcher is unaware of the level of detail the publisher might have linked such information to the electronic object. For a Sharp Search, upon selecting a first search button 580, the object management system produces search results listing those electronic objects (e.g. documents) which match with the search parameters in every category. For a Standard Search, however, upon selecting a second search button 585, the object management system produces search results listing including those electronic objects which have no entry in a category. Hence, the Sharp Search function provides a refined search capability over the Standard Search function.

Even though Search profiles are individual objects dedicated for a user, the object management system works with a unique identifier (ID) for every search profile. It is therefore possible that a user can share a once defined search profile, which she considers as useful with any number of colleagues. Such sharing involves a two-step process: (1) the unique ID for the personal search profile is known; and (2) the colleague needs to import the profile conditions into his own set of search profiles by using this number as a reference.

The unique ID of a search profile is revealed in the Edit Search Dialogue as shown in FIG. 5C. When a search profile is selected in profile entry 530, a unique ID 555 of the selected profile is displayed within dialogue box 500. In the example below, the search profile with the name “Personal Search” has the unique ID 10085.

Thereafter, the user who wants to import the profile of Personal Search has to press the Import button 590 and enter the unique ID into a chosen field of a generated dialogue 595. The Personal Search profile set 534 will then be added to the list of the user performing the import. This profile will also appear in the user's list with the same name as used by the originator.

C. Publishing Dialogue Window

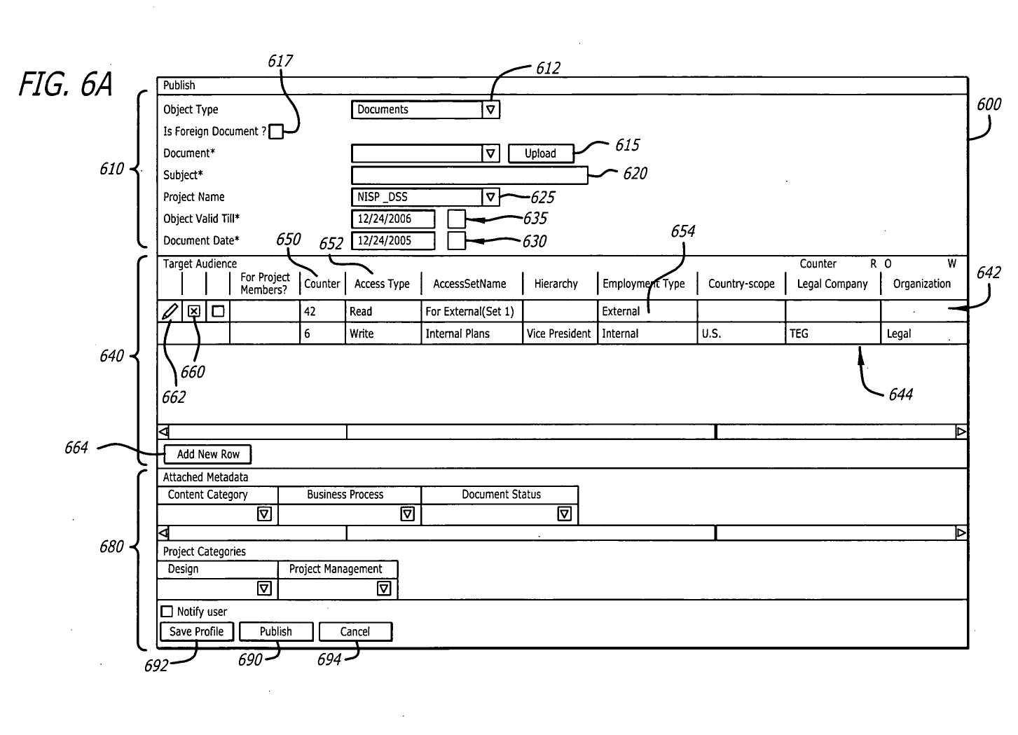

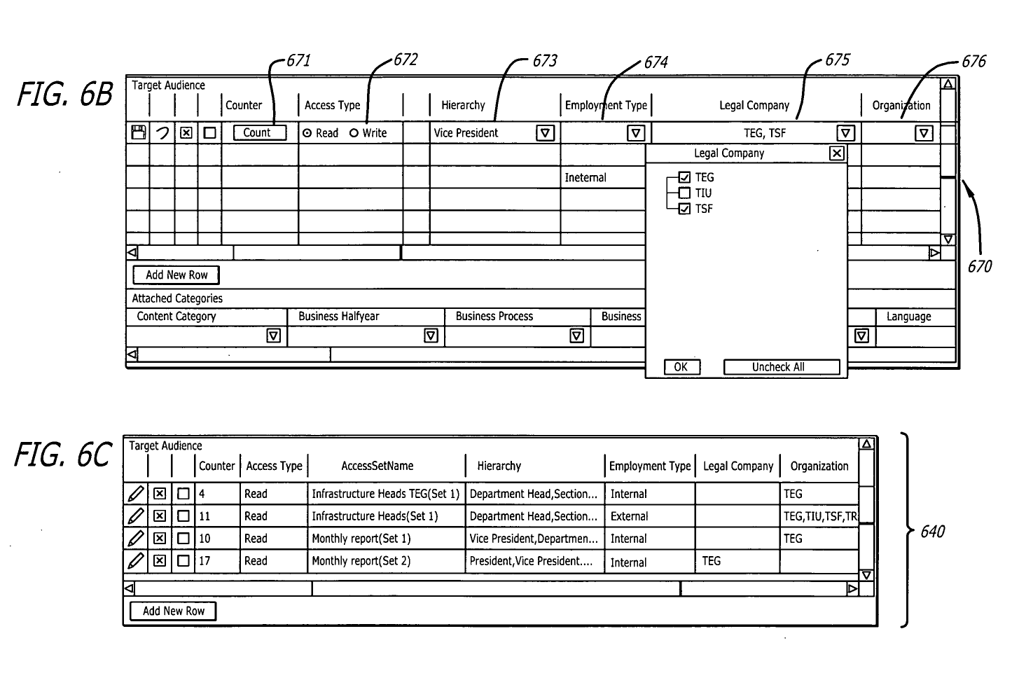

Referring now to FIG. 6A, an exemplary embodiment of a publishing dialogue window 600 is shown. This dialogue 600 offers the option to register new electronic objects (e.g., documents, applications, links, etc.) into a central database, define the audience for read and/or write access of the electronic object and also describe their content. This may be conducted by assigned metadata where the user assigns the metadata to the electronic object.

The publishing of an electronic object features multiple phases. For instance, as an illustrative embodiment, the publishing operations include a loading phase, an access rule definition phase, and a metadata selection phase. All of these phases are captured within publishing dialogue window 600.

During the loading phase, a first section 610 of publishing dialogue window 600 is filled out by the publisher to identify the electronic object with information other than the metadata described below. For instance, according to one embodiment of the invention, the publisher may identify the object type 612 as being one of a document, application, link, image or the like by selecting entry 610.

In addition, first section 610 of publishing dialogue window 600 includes the following entries: Document entry 615, subject 620, project name 625, document date 630 and validity parameter 635. Document entry 615 allows the publisher to identify an object to be uploaded to a central server. The object may be a stored locally, and if stored on a remotely located system, a foreign document element 617 is set to identify that the object to be uploaded from an archival system. Subject 620 is an entry that allows the publisher to enter the topic that the subjective content of the electronic object is directed. Project name entry 625 allows the publisher to identify the project associated with the electronic object while document date 630, different from publishing date, provides the date for which the document is relevant. For example: At May 12^{th} a meeting minute document is published about a meeting which has taken place on May 10^{th}. In this case, the publish date (automatically retrieve) is May 12^{th} but the document date can be set with May 10^{th}. The validity of the document may be set by validity parameter entry 635 so that documents may be denoted as invalid to the user, and perhaps automatically deleted from the server after the validity deadline has elapsed.

During the access rule definition phase, a second section 640 of publishing dialogue window 600 is filled out by the publisher to define the access rule that will define what users, other than the publisher, have access to the published object. Access to the document is assigned based on selected access sets such as a first access set 642 and a second access set 644 as shown. For instance, as shown, first access set 642 features 42 users (both employees and external) as represented by counter entry 650 who are assigned read access. These features are represented within the Access Type entry 652 and the Employment Type entry 654. First access set 642 can be deleted by selecting a first control element 660, can be edited by selecting a second control element 662. A new access set may be created by selection of Add New Row button 664 within second section 640.

Upon selecting a dialog button for editing or creating an access set, a dialogue window 670 shown in FIG. 6B is generated. Dialogue window 670 includes a counter entry 671, an access type entry 672, a hierarchy entry 673, an employment type entry 674, a company entry 675 and an organization entry 676. The list of the four (4) later-mentioned entries 673-676 are optional and elements of a possibly longer list of attributes dependent on the number and types of AD attributes a company has selected to apply in order to describe and organize its employees.

Herein, count button 671 is used to calculate the number of users that would have access to the published electronic object. Access type entry 672 is configured to identify whether users of the published object are allowed read and/or write access. Hierarchy entry 673 is configured to identify at what position level a user would be provided access to the published documents. For instance, according to one embodiment, restricting the level to a vice-president may restrict access solely to users with vice-president positions. Employment type entry 674 is configured to identify what employment level, if any, is needed to access the published document. For instance, employee level may be chosen or perhaps contractor or non-employee level may be chosen.

If selected, the access set illustrated in FIG. 6B will give Read access rights for the published document to all vice presidents (Hierarchy) who are working in either of two companies identified as TEG and TSF.

A user can save any number of Access Rules for her personal use in order to avoid a redefinition when publishing further objects to the same audience. Once saved, the stored access rules appear for selection in section 640 of the grid of publishing dialogue window 600 as shown in FIG. 6C.

Of course, in order to quickly describe the content of the published document, the user can select values from standardized category lists associated with information concerning the document and attached metadata.

During the metadata selection phase, a third section 680 of publishing dialogue window 600 is filled out by the publisher to identify what metadata is used for subsequent searching for the electronic object. In the metadata selection phase, the user can select metadata from the standardized list of attached category metadata such as content category, business process, document status, or the like.

After sections 610, 640 and 680 have been filled out, the publisher can publish the identified electronic object by selection of the Publish button 690. Moreover, the access rule created in section 640 can be saved by selection of Save Profile button 692. To close the window, CLOSE button 694 is selected.

C. Check-in/Check-Out Windows

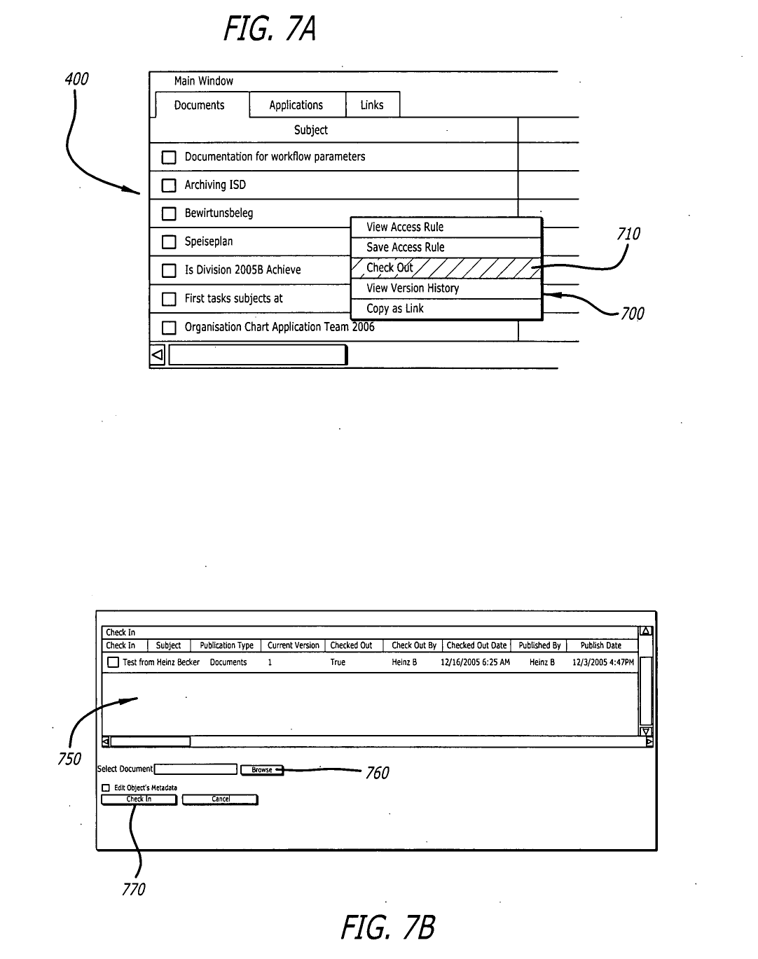

Referring now to FIGS. 7A and 7B, exemplary embodiments of check-out and check-in processes is shown. It is contemplated that, for an effective object management system, any changes to electronic objects, their content, their metadata and/or their access rules are logged. Any modification must be traceable by these system logs. Thus, according to one embodiment of the invention, any type of modification is performed via a check-out/check-in process.

Prior to any change, the user would check out the object. In order to do this, a context menu 700 in main window 400 is opened as shown in FIG. 7A. As shown, the menu option “Check out” 710 is selected. According to one embodiment of the invention, the publisher and all users to whom “write” permission was granted for the specific electronic object via the access rule defined by the publisher are allowed to check out an electronic object. The system replies with a message (not shown) that the check-out was successful, provided the electronic object is not in a checked-out state already. In case the user attempts to check out an object that has been checked out and has not yet been checked in, the system will reply with a message to inform the user about this condition.

Referring now to FIG. 7B, the check-in process allows an update of an object in the database with modified content and/or metadata. According to one embodiment of the invention, a check-in dialogue window 750 is generated upon selection of check-in dialogue button 495 located in main window 400 of FIG. 4A. Check-in dialogue button 495 is only active if there are electronic objects pending for check in. As shown in FIG. 7B, in the grid of this window, all objects that have been checked out by the user and have not been returned via the check-in process are visible. As shown, the object has to be selected for which the check in process shall be started. For the selected object, three options of modification are possible:
(1) Changing the content of the electronic object
(2) Changing metadata and/or header information of the electronic object
(3) The combination of the options (1) & (2)

For modification of the content, the user can press an upload button 760 in check-in dialogue window 750 and can load the new version of the object from her file system. Then, check-in button 770 can be pressed. The object management system will reply with a message that the object is checked in again.

For modification of metadata and/or object header data, the user selects the checkbox entitled “Edit Object's Metadata” and waits until publishing dialogue window 600 of FIG. 6A has opened. In this window, all fields are populated with the header and metadata values of the electronic object. Now, the user can modify any of these parameters within publishing dialogue window 600 and close that window:
(1) Modification of the object's access rule
(2) Modification of the object's attached metadata
(3) Modification of the object's Subject title, Document date and the “Object valid till” date.

When all modifications are completed, the user can press check-in button 770 to close check-in dialogue window 750. The system will reply with a message that the object is checked in again.

While the invention has been described in terms of several embodiments of the invention, those of ordinary skill in the art will recognize that the invention is not limited to the embodiments of the invention described, but can be practiced with modification and alteration within the spirit and scope of the below claims. The description is thus to be regarded as illustrative instead of limiting.

What is claimed is:

1. A method comprising:
determining if a user has access rights to an electronic object stored in a database; and
precluding display of information associated with the electronic object if the user fails to have access rights to the electronic object.

2. The method of claim 1, wherein the determining if the user has access rights to the electronic object includes comparing Active Directory attributes of the user to the access rights assigned to the electronic object.

3. The method of claim 2, wherein the access rights of the electronic object are directed solely to attributes of a targeted user and are not directed to the targeted user by name, the access rights include one or more of the following: an organizational position, a business area, and a job responsibility held by the targeted user.

4. The method of claim 1, wherein the access rights include a first set of metadata assigned to the electronic object that is selected by a publisher of the electronic object.

5. The method of claim 4, wherein the access rights further include a second set of metadata assigned to the electronic object automatically without any action by the publisher.

6. The method of claim 1 further comprising:
conducting a search for the electronic object based on selected categories of metadata including the access rights.

7. The method of claim 1, wherein the conducting of the search includes generating a dialogue window defining search parameters according to metadata within at least one of the first set of metadata and the second set of metadata.

8. The method of claim 1, wherein prior to determining if the user has access rights to the electronic object, the method comprises:
registering the electronic object into a central database and defining the access rights to the electronic object by a publisher of the electronic object.

9. The method of claim 8, wherein the registering of the electronic object includes identifying the electronic object by object type.

10. The method of claim 9, wherein the registering of the electronic object further includes defining access rules for the electronic object.

11. The method of claim 10, wherein the registering of the electronic object further includes providing the metadata used for subsequent searching for the electronic object.

12. A software program stored within a storage medium that, when executed by a processor, enable sharing of a plurality of electronic objects, the software program comprising:
a first software module to control generation of a publishing dialogue window, the publishing dialogue window including a plurality of sections that comprise (i) a first section including fields adapted to receive information to identify an electronic object, (ii) a second section including fields adapted to receive information to define an access rule for accessing the electronic object, and (iii) a third section including fields adapted to receive information to be used for subsequent searching for the electronic object; and
a second software module to display the published dialogue window for entry of information within the fields of one or more of the plurality of sections.

13. The software program of claim 12, wherein the software program further comprising:
a third software module to control generation of an edit search dialogue window including a plurality of sections that comprise (i) a fourth section including fields adapted to receive information to adjust, delete or add a selection rule that defines criteria upon which a search is conducted, and (ii) a fifth section including fields adapted to receive an identifier for a predefined search to be imported as a new search profile of a set of search profiles associated with the user.

14. A method comprising:
selecting access rights associated with an electronic object by a publisher of the electronic object;
uploading the electronic object into a database; and
precluding display of information associated with the electronic object if the user fails to have access rights as selected by the publisher.

15. The method of claim 14, wherein prior to precluding display of the information, the method further comprises determining if a user has access rights to the electronic object stored in a database by comparison of Active Directory attributes of the user to the access rights associated with the electronic object.

16. The method of claim 15, wherein the access rights of the electronic object are directed solely to attributes of a targeted user and are not directed to the targeted user by name.

17. The method of claim 14, wherein the access rights include a first set of metadata assigned to the electronic object that is selected by the publisher of the electronic object.

18. The method of claim 17, wherein the access rights further include a second set of metadata assigned to the electronic object automatically without any action by the publisher.

19. The method of claim 14 further comprising:
conducting a search for the electronic object based on selected categories of metadata including the access rights.
